(19) United States
(12) Patent Application Publication
(10) Pub. No.: US 2007/0234845 A1
(43) Pub. Date: Oct. 11, 2007

(54) Roller Thrust Assembly

(76) Inventors: Walter Richard Gist JR., Greer, SC (US); Gary T. Schick, Easley, SC (US)

Correspondence Address: MICHAEL BEST & FRIEDRICH LLP, 100 E WISCONSIN AVENUE, Suite 3300, MILWAUKEE, WI, 53202, US

(21) Appl. No.: 11/587,087

(22) PCT Filed: Feb. 8, 2006
(86) PCT No.: PCT/US06/04521

§ 371 Date: Oct. 20, 2006

Related U.S. Application Data
(60) Provisional application No. 60/651,393, filed on Feb. 9, 2005.

(51) Int. Cl. F16H 53/06

(52) U.S. Cl. 74/569

(57) ABSTRACT

A cam thrust assembly that includes at least one rotatable cam plate and at least one roller retaining recess defined in the cam plate. The roller retaining recess has an inner radius and an outer radius and defines a ramp surface having a shallow portion and a deep portion. The cam thrust assembly further includes a tapered roller positioned in the roller retaining recess on the ramp surface for movement along the ramp surface. At least a portion of the ramp surface is curved between the shallow portion and the deep portion in the direction of the roller travel.

### CROSS-REFERENCE TO RELATED APPLICATIONS

This application claims the benefit of U.S. Provisional Patent Application No. 60/651,393, filed Feb. 9, 2005, the entire contents of which are hereby incorporated by reference.

### BACKGROUND

The present invention relates to a roller thrust assembly, and more particularly to a roller thrust assembly that includes a roller thrust ramp.

Many applications require a releasable mechanism capable of providing a thrust force. One such thrust mechanism provides a cam rolling assembly wherein rolling elements rotate relative to a ramp on a cam plate, thereby forcing the cam plate axially as the rolling elements move from the deep portion of the ramp to a shallower portion of the ramp.

For example, many vehicles provide a steering column that permits tilting or tilting and telescoping thereof to meet the users' preferences. Upon proper adjustment, the steering column must be fixed to prevent movement of the steering column during vehicle operation. Cam thrust mechanisms have been used to provide a locking mechanism that allows relatively easy release to allow adjustment, but also provides adequate fixing of the steering column.

Another example in which cam thrust mechanisms are utilized are parking brake actuators. As the brake lever is lifted, the cam plate is rotated and an axial thrust load is achieved to actuate the brake.

These are just two examples of applications using cam thrust mechanisms. As these applications evolve and other applications are developed, there is a desire to provide higher thrust loads and higher lifts while reducing the rotation angle and package size of the cam plate.

### SUMMARY

To achieve higher thrust loads, needle rollers have been found to provide a higher load over balls. To achieve higher lifts with the same rotation angle dictates steeper angles for the roller trajectory, the path the roller centerline follows as it rolls over the ramp surface. The roller trajectory and the roller diameter define the ramp surface. Large roller diameters and steep trajectory curves create sharp ramp surfaces which in turn create high surface contact stresses. While it is possible to “flatten out” the ramp surface by using smaller roller diameters, such a configuration prevents the use of roller retainers which are preferred to ensure the rollers stay in phase. The present inventors have found a configuration that allows larger thrust force with smaller rotation angles.

In one embodiment, the invention provides a cam thrust assembly that includes at least one rotatable cam plate and at least one roller retaining recess defined in the cam plate. The roller retaining recess has an inner radius and an outer radius, and the retaining recess defines a ramp surface having a shallow portion and a deep portion. The cam thrust assembly further includes a tapered roller positioned in the roller retaining recess on the ramp surface for movement along the ramp surface. At least a portion of the ramp surface is curved between the shallow portion and the deep portion in the direction of the roller travel.

In another embodiment, the invention provides a steering column assembly that includes a steering column rotatable about an axis and a cam thrust assembly. The cam thrust assembly includes at least one rotatable cam plate that is rotatable between a first position and a second position. The cam thrust assembly further includes at least one roller retaining recess defined in the cam plate. The roller retaining recess has an inner radius and an outer radius, and the retaining recess defines a ramp surface having a shallow portion and a deep portion. The cam thrust assembly further includes a tapered roller positioned in the roller retaining recess on the ramp surface for movement along the ramp surface. At least a portion of the ramp surface is curved between the shallow and the deep portion in the direction of the roller travel. The steering assembly further includes a lever operable to rotate the at least one rotatable cam plate between the first and second positions. When the cam plate is in the first position, the steering column is rotatable about the axis, and when the cam plate is in the second position rotation of the steering column about the axis is substantially prevented.

### BRIEF DESCRIPTION OF THE DRAWINGS

FIG. 1 is a perspective view of a cam thrust assembly embodying the present invention.

FIG. 2 is a perspective view of a tapered roller utilized in the cam thrust assembly of FIG. 1 and a wire frame illustration of the tapered roller.

FIG. 3 is a perspective view of a cam plate utilized in the cam thrust assembly of FIG. 1.

FIG. 4 is a cross-sectional view of the cam plate of FIG. 3, including a tapered roller, taken along line 4-4 of FIG. 3 with cross-hatching removed for clarity.

FIGS. 5a -5c are cross-sectional views of the cam plate of FIG. 3, including the tapered roller, taken along lines 5a-5a, 5b-5b, and 5c-5c of FIG. 3 with cross-hatching removed for clarity.

FIG. 5d is a graphical representation of the tapered roller traveling along a recess of the cam plate of FIG. 3.

FIG. 6 is a perspective view of a cam plate that includes a tapered roller ramp and a roller ramp for a cylindrical roller, illustrating the differences in the ramps.

FIG. 7 is a cross-sectional elevational view a steering column assembly that includes the cam thrust assembly of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The present invention will be described with reference to the accompanying drawing figures wherein like numbers represent like elements throughout. Certain terminology, for example, “inner”, “outer”, “top”, “bottom”, “right”, “left”, “front”, “frontward”, “forward”, “back”, “rear” and “rearward”, is used in the following description for relative descriptive clarity only and is not intended to be limiting.

### DETAILED DESCRIPTION

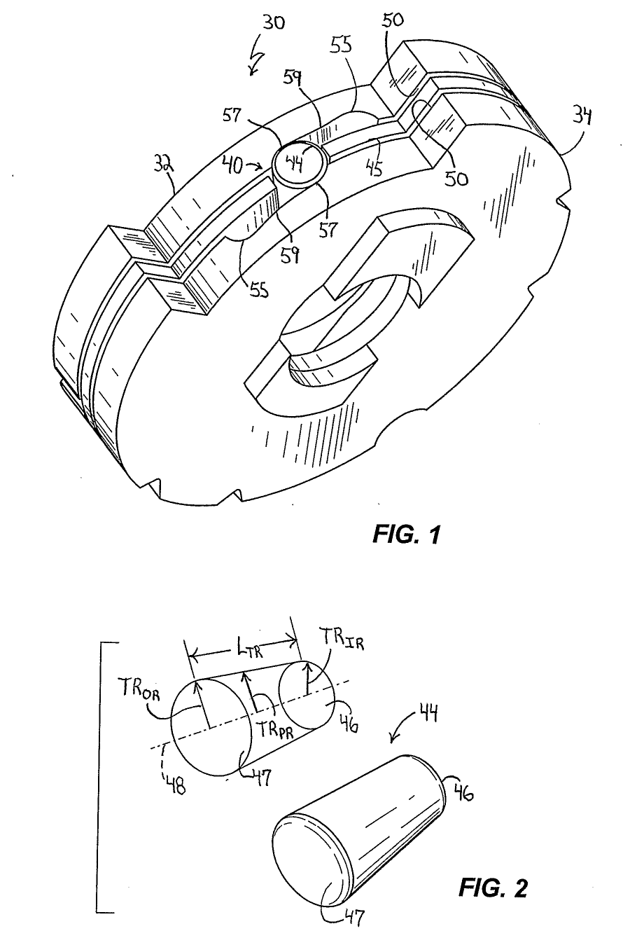

FIG. 1 illustrates a cam thrust assembly 30 that includes a pair of opposed cam plates 32 and 34 with a roller assembly 40 positioned therebetween. While the illustrated cam thrust assembly 30 includes the two opposed cam plates 32, 34, the cam thrust assembly 30 may utilize one cam plate or more than two cam plates.

The illustrated roller assembly 40 includes three tapered rollers 44 (only one visible in FIG. 1) and a retainer plate 45 that receives the tapered rollers 44. The retainer plate 45 maintains a generally equal circumferential distance between the tapered rollers 44, thereby keeping the rollers 44 in phase as they roll with respect to the cam plates 32, 34. While the illustrated cam thrust assembly 30 includes three tapered rollers 44, the cam thrust assembly can include one, two, or more than three of the tapered rollers 44.

FIG. 2 illustrates one of the tapered rollers 44. Each of the tapered rollers 44 are generally the same and therefore only one of the tapered rollers 44 will be described in detail. The tapered roller 44 includes an inner end 46 having a radius TR_{IR}, an outer end 47 having a radius TR_{OR} that is larger than the radius TR_{IR} of the inner end 46. A roller axis 48 is defined by a line that extends through the center of the outer end 47 and the inner end 46. The tapered roller 44 has a length L_{TR} and a pitch location that is located substantially halfway between the inner and outer ends 46, 47 (i.e. one-half of the length from either the inner or outer ends 46, 47). A tapered roller pitch radius TR_{PR} is defined as the radius of the tapered roller 44 at the pitch location. In the illustrated construction, the length L_{TR} of the tapered roller 44 is greater than or approximately equal to twice the tapered roller pitch radius TR_{PR}. This construction is particularly suited for applications with the cam thrust assembly 30 (discussed in more detail below). In other constructions, the length L_{TR} of the tapered roller 44 can be less than twice the tapered roller pitch radius TR_{PR}.

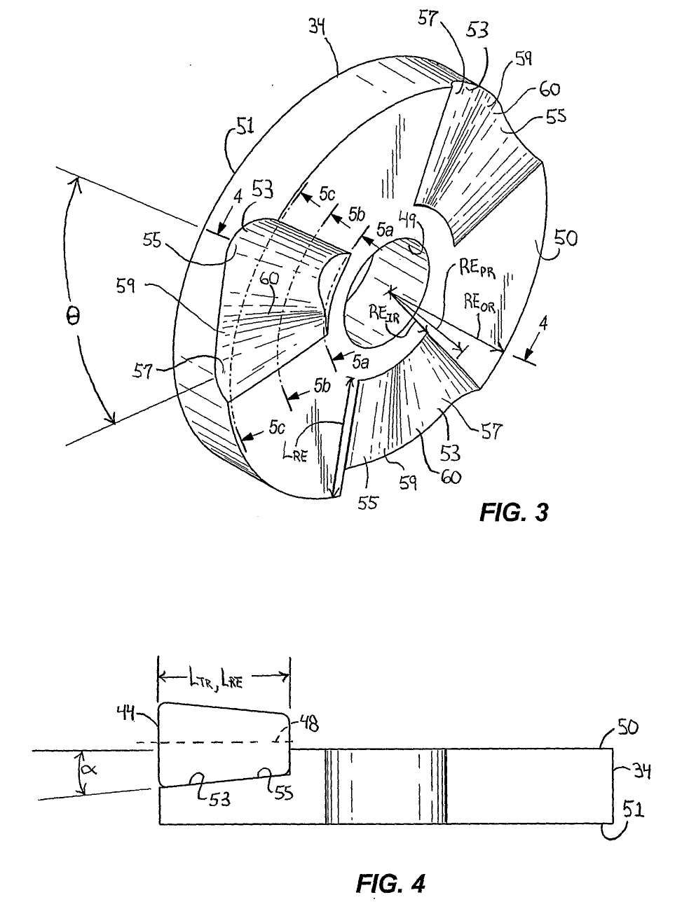

Referring to FIG. 1, the cam plates 32 and 34 generally include the same features, and therefore only the cam plate 34 will be described in detail below. Referring to FIG. 3 the illustrated cam plate 34 is a generally circular shaped disk that includes a central bore 49 and generally planer inner and outer surfaces 50 and 51. Comparing the cam plates 34 of FIGS. 1 and 3, the cam plate 34 of FIG. 3 is illustrated with various features removed from the perimeter of the cam plate 34 of FIG. 1 for clarity. It should be understood that the cam plates 34 illustrated in FIGS. 1 and 3 are just one possible construction and the cam plates can take other shapes and include other surface features.

With continued reference to FIG. 3, three recesses 53 are formed on the inner surface 50 of the cam plate 34. The recesses 53 include a deep portion 55 and a shallow portion 57. While the illustrated cam plate 34 includes three recesses 53, in other constructions, the cam plate 34 can include one, two, or more than three recesses 53. Each of the three recesses 53 are generally the same, and therefore only one recess 53 will be described in detail.

With continued reference to FIG. 3, the recess 53 has an inner radius RE_{IR} and a recess outer radius RE_{OR}. The difference between the inner recess radius RE_{IR} and the outer recess radius RE_{OR} defines a length L_{RE} of the recess 53 (i.e., L_{RE}=RE_{OR}−RE_{IR}). A radial pitch location of the recess 53 is defined as a point substantially halfway between the inner radius RE_{IR} and the outer radius RE_{OR}, and therefore a recess pitch radius RE_{PR} is defined as the distance between the center of the bore 49 and the radial pitch location.

Referring to FIG. 4, the recess 53 is configured to receive one of the tapered rollers 44, and in the illustrated construction the length L_{TR} of the tapered roller 44 is approximately equal to the length L_{RE} of the recess 53, and thus the pitch location of the recess 53 substantially coincides with the pitch location of the tapered roller 44. In other constructions, the tapered roller may not be the same length as the recess and thus the pitch locations would not coincide.

With continued reference to FIG. 4, the recess 53 is tapered in a radial direction at an angle α with respect to the inner surface 50. While only the deep portion 55 is illustrated in FIG. 4, the shallow portion 57 is also tapered at generally the same angle α a as the deep portion 55. The angle α can be chosen based on the thrust load requirements of the application, and therefore may vary depending on the particular application. In the illustrated construction, the shallow and deep portions 57, 55 receive the tapered roller 44 such that the roller axis 48 is generally parallel to the inner surface 50. Thus, the taper of the roller 44 is substantially the same as the angle α. In other constructions, the roller axis 48 may not be parallel to the inner surface 50.

Referring to FIG. 3, a ramp 59, having a curved ramp surface 60, extends circumferentially between the deep and shallow portions 55, 57. The ramp surface 60 is contoured to minimize sharp changes in the ramp surface 60 and to ensure the ramp surface 60 maintains continuous contact with the tapered roller 44 throughout the operating range of the cam thrust assembly 30. While the illustrated ramp 59 is generally curved along the entire length L_{RE} of the recess 53 in the circumferential direction or in the direction of roller travel, in other constructions, the ramp may include a curved portion and a portion that is tapered or inclined linearly, but is not curved. In yet other constructions, the ramp may include more than one curved portion, each with a different radius of curvature,

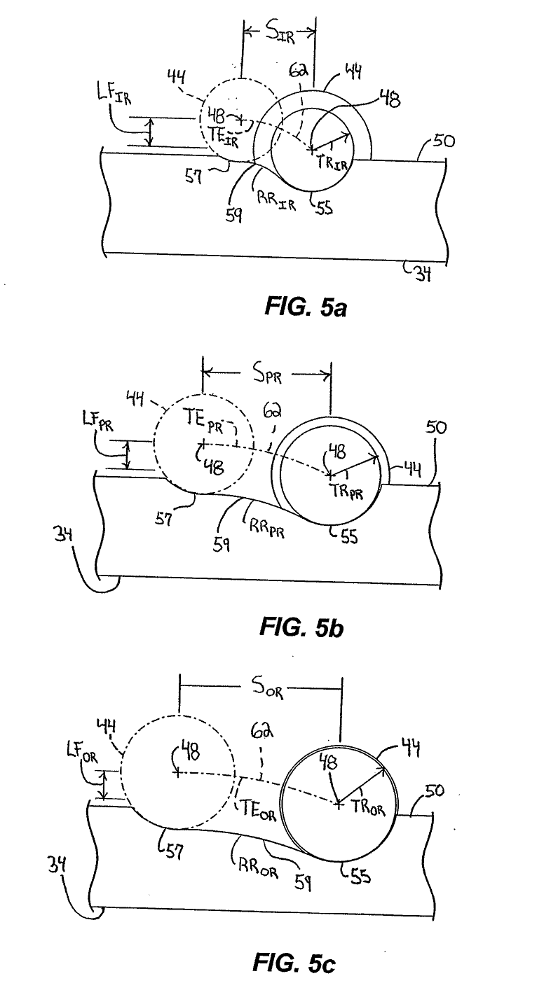

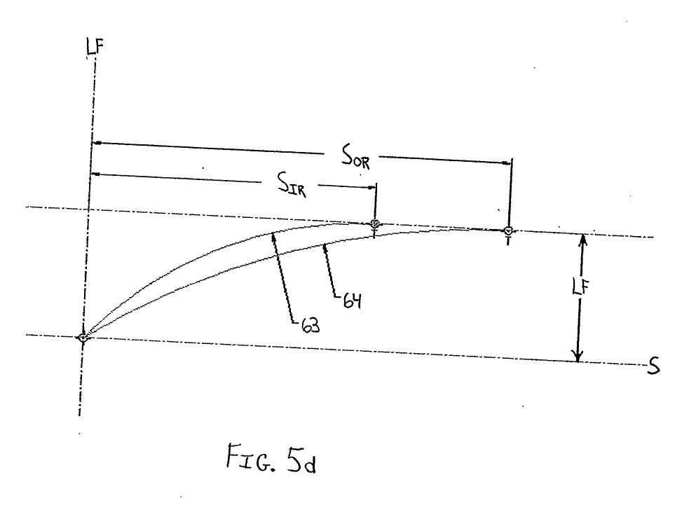

Referring to FIGS. 4 and 5a-5c, the recess 53 is contoured in both the circumferential and radial directions such that the curved ramp 59 has a radius of curvature or a ramp radius RR_{OR} at the recess outer radius RE_{OR} (FIG. 5c) that is greater than a ramp radius RR_{IR} at the recess inner radius RE_{IR} (FIG. 5a). A ramp radius RR_{PR} at the recess pitch radius RE_{PR} (FIG. 5b) is greater than the ramp radius RR_{IR} at the recess inner radius RE_{IR} but less than the ramp radius RR_{OR} at the recess outer radius RE_{OR}. Therefore,
RR_{IR<RR}_{PR<RR}_{OR}

In one construction, the ramp radius RR_{PR} at the recess pitch radius RE_{PR} is less than or approximately equal to the roller radius TR_{PR} at the pitch location of the tapered roller 44. This construction is particularly suited for and defines what those of skill in the art would consider high lift applications of the cam thrust assembly 30. However, in other constructions, the ramp radius at the recess pitch radius can be greater than the roller radius at the pitch location.

Referring to FIGS. 3 and 5a-5c, during operation of the cam thrust assembly 30, the cam plate 34 rotates about the center of the bore 49 through an angle θ, such that the tapered roller 44 rolls along the curved ramp 59 between the shallow and deep portions 57, 55. A roller trajectory 62 is defined by the path the roller axis 48 follows as it rolls back and forth between the deep and shallow portions 55, 57. As a result of the curved ramp 59, the roller trajectory 62 is also curved and has a roller trajectory radius TE. In the illustrated construction, at any point along the curved ramp 59, the trajectory radius TE is equal to the ramp radius RR plus the tapered roller radius TR. Therefore,
TE_{OR}=RR_{OR}+TR_{OR}
TE_{IR}=RR_{IR}+TR_{IR}
TE_{PR}=RR_{PR}+TR_{PR}

With continued reference to FIGS. 5a-5c, as the tapered roller 44 travels from the deep portion 55 to the shallow portion 57 the roller axis 48 is lifted a distance LF in the axial direction, and the roller axis 48 sweeps a rotational distance S. As a result of the taper of the recess 53 being contoured in both the radial and circumferential directions, the lift LF at any point between the recess inner radius RE_{IR} and recess outer radius RE_{OR} is generally equal. Therefore,
LF_{IR=LF}_{PR=LF}_{OR}

Referring to FIGS. 1 and 5a-5c, in the illustrated construction, the lift LF is less than the tapered roller radius TR_{PR} at the radial pitch location because the tapered rollers 44 are received the recess 53 of the cam plate 34; and therefore, the lift LF cannot be equal to or exceed the pitch radius TR_{PR} of the tapered roller 44 in the illustrated construction of the cam assembly 30 where the two cam plates 32, 34 are utilized. In other constructions, the cam plate 34 may not include a recess, but rather a protrusion along which the roller travels, and thus the lift can be equal to or more than the tapered roller radius at the radial pitch location.

The rotational distance S that the roller axis 48 sweeps is a function of the angle θ that the cam plate 34 is rotated through about the center of the bore 49 and the radial location along the recess 53. At any radial location along the recess 53, the distance S is equal to the radius measured from the center of the bore 49 times the angle θ, and therefore,
S_{IR}=RE_{IR}×θ
S_{PR}=RE_{PR}×θ
S_{OR}=RE_{OR}×θ

FIG. 5d is a two-dimensional graphical illustration of the lift LF versus the distance S, which illustrates the roller trajectory for one construction of the curved ramp 59 and tapered roller 44. An arc 63 illustrates the roller trajectory at the recess inner radius RE_{IR} and an arc 64 illustrates the roller trajectory at the recess pitch radius RE_{PR}. As described above, the lift LF is equal at any point between the recess inner radius RE_{IR} and recess outer radius RE_{OR} and the sweep distance S is proportionately smaller at the recess inner radius RE_{IR} than at the recess outer radius RE_{OR}. Therefore, the trajectory radius TE_{IR} at the ramp recess inner radius RE_{IR} is smaller than the trajectory radius TE_{PR} at the ramp recess pitch radius RE_{PR}, and recall,
TE_{PR}=RR_{PR}+TR_{PR}
TE_{IR}=RR_{IR}+TR_{IR}

Therefore, the smaller the trajectory radius TE, the smaller the ramp radius RR if the roller is to maintain constant lift LF and contact with the curved ramp surface 60 at all radial locations of the roller 44. A small ramp radius RR can cause high stress concentrations on the roller 44, and thus it is undesirable to reduce the ramp radius RR below a predetermined amount depending on the radius TR of the roller 44 and the particular application of the cam thrust assembly 30. Therefore, by utilizing a roller 44 with an inner radius TR_{IR} that is less the outer radius TR_{OR} (i.e., a tapered roller) the ramp radius RR can be increased, especially at the recess inner radius RE_{IR} for the same trajectory radii TR.

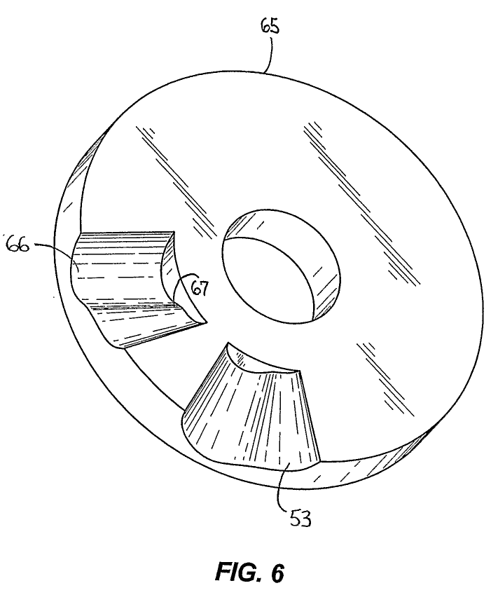

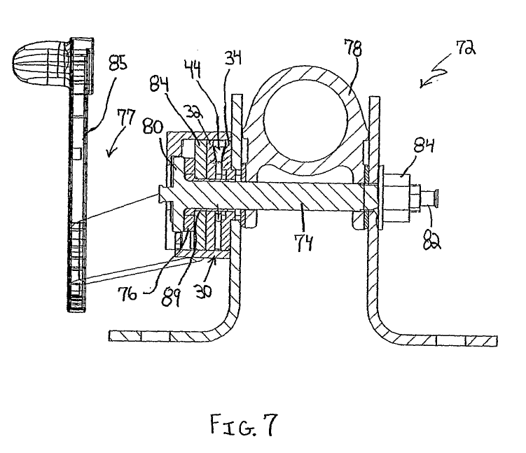

FIG. 6 illustrates a cam plate 65 that includes a recess 66 configured to receive a typical cylindrical roller (i.e. constant diameter or radius) and the recess 53, described above, that is configured to receive the tapered roller 44. Referring to the recess 66, in order to achieve a constant lift with a cylindrical roller, the ramp radius at a point 67 near the inner radius becomes undesirably sharp (i.e., a small ramp radius). The small ramp radius at point 67 creates undesirably high stresses on the roller that can lead to premature failure of the roller or cam plate 65. However, increasing the ramp radius of the recess 66 for a cylindrical roller will either decrease the lift or increase the angle that the cam plate has to be rotated, or a combination of both.

In several applications of the cam thrust assembly 30, it is desirable to both increase the lift LF and decrease the angle θ thought which the cam plate 34 is rotated. However, either increasing the lift LF or decreasing the angle θ will result in a smaller trajectory radius TE which in turn results in a smaller ramp radius RR, especially at inner radii of the recess. Therefore, by utilizing the tapered roller 44, the cam assembly 30 can achieve a relatively high lift LF while minimizing the angle θ through which the cam plate 34 is rotated. Furthermore, utilizing a tapered roller with the ramp 59, described above, is particularly beneficial in applications that utilizes longer roller (i.e., rollers with a length greater than a pitch radius of the roller) because the effect of a smaller ramp radius RR increases with the length of the roller.

Referring to FIGS. 1 and 3, in operation, if the cam thrust assembly 30 begins with each tapered roller 44 positioned in an opposed pair of the deep portions 55, as the plates 32, 34 are rotated relative to one another, the tapered rollers 44 ride up the opposed ramps 59. When the cam plates 32, 34 have been rotated through the angle θ relative to each other, the tapered rollers 44 are received in their respective shallow portions 57. The positioning of the tapered rollers 44 within the diminished depths of the shallow portions 57 causes the plates 32 and 34 to push apart (i.e. separate) and thereby provide axial thrust or spreading. A separation is defined as the difference in the distance between the inner surfaces 50 of the cam plates 32, 34 when the rollers 44 are in the shallow and deep portions 57, 55. In the illustrated construction, the separation is equal to twice the lift.

FIG. 7 illustrates the cam thrust assembly 30 used in conjunction with a steering column locking assembly 72. The steering column locking assembly 72 includes a tie bolt 74 that extends through a thrust bearing assembly 76, a lever member 77, the cam thrust assembly 30 and a steering column 78, The tie bolt 74 terminates in a retaining plate 80 (which may be an integral part of the bolt 74) at one end and has a free end 82 that is configured for securement relative to the steering column 78. For example, the free end 82 is threaded to receive a nut 84 or the like.

The illustrated lever member 77 includes an extending handle 85 connected to a plate 84. The plate 84 may be formed integral with the handle 85 or may be a separate component attached thereto. The plate 84 has an aperture 89 therethrough configured to receive the tie bolt 74 such that the plate 84 may be rotated about the tie bolt 74. In the illustrated embodiment, the thrust bearing assembly 76 is positioned between the retaining plate 80 and the lever plate 84 to further facilitate rotation of the lever member 77. The opposite side of the lever plate 84 is configured to engage the cam thrust assembly 30 to rotate the cam plate 32.

Referring to FIGS. 1 and 7, in operation, if the steering column locking assembly 72 begins in the locked position, the lever 85 is rotated from a starting position to correspondingly rotate the lever plate 84 and the cam plate 32. Rotation of the cam plate 32 relative to the cam plate 34 causes the tapered rollers 44 to move along the curved ramps 59 from the shallow portions 57 to the deep portions 55, thereby causing the cam plates 32, 34 to move towards each other and to unlock the steering column 78. The user can then rotate the steering column 78 about the tie bolt 74 to position the steering column 78 in a desired position. Then the lever 85 is rotated back to the starting position which causes the cam plates 32, 34 to rotate relative to each other forcing the rollers 44 to move from the deep portions 55 to the shallow portions 57. This movement causes the cam plates 32, 34 to separate resulting in a thrust force that locks the steering column locking assembly 72 and substantially prevents rotation of the steering column 78 about the tie bolt 74.

What is claimed is:

1. A cam thrust assembly comprising:
at least one rotatable cam plate;
at least one roller retaining recess defined in the cam plate and having an inner radius and an outer radius, the retaining recess defining a ramp surface having a shallow portion and a deep portion; and
a tapered roller positioned in the roller retaining recess on the ramp surface for movement along the ramp surface, wherein at least a portion of the ramp surface is curved between the shallow portion and the deep portion in the direction of the roller travel.

2. The cam thrust assembly of claim 1, wherein the tapered roller has a radial pitch location with a roller radius at the pitch location, and wherein the ramp surface has a radius at the pitch location that is less than or equal to the tapered roller radius at the pitch location.

3. The cam thrust assembly of claim 1, wherein the assembly includes two cam plates, at least one of the two cam plates is rotatable and each of the two cam plates including at least one roller retaining recess, and wherein the cam plates achieve a maximum separation when the tapered roller reaches the shallow portion of the ramped surfaces of each of the respective recesses, and wherein the maximum separation is less than the tapered roller diameter at a radial pitch location.

4. The cam thrust assembly of claim 1, wherein the tapered roller has a length greater than or equal to a diameter of the tapered roller at a radial pitch location.

5. The cam thrust assembly of claim 1, further comprising,
at least two roller retaining recesses defined in the cam plate;
a tapered roller positioned in each of the at least two roller retaining recesses; and
a retainer configured to receive the tapered rollers and maintain a generally equal circumferential distance between the tapered rollers.

6. A steering column assembly comprising:
a steering column rotatable about an axis;
a cam thrust assembly including,
at least one rotatable cam plate, the cam plate rotatable into a first position and a second position;
at least one roller retaining recess defined in the cam plate and having an inner radius and an outer radius, the retaining recess defining a ramp surface having a shallow portion and a deep portion; and
a tapered roller positioned in the roller retaining recess on the ramp surface for movement along the ramp surface, wherein at least a portion of the ramp surface is curved between the shallow portion and the deep portion in the direction of the roller travel;
a lever operable to rotate the at least one rotatable cam plate into the first and second positions, wherein when the at least one cam plate is in the first position, the steering column is rotatable about the axis, and when the at least one cam plate is in the second position, rotation of the steering column about the axis is substantially prevented.

7. The steering column assembly of claim 6, wherein the tapered roller has a radial pitch location with a roller radius at the pitch location, and wherein the ramp surface has a radius at the pitch location that is less than or approximately equal to the tapered roller radius at the pitch location.

8. The steering column assembly of claim 6, wherein the assembly includes two cam plates, at least one cam plate rotatable and each cam plate including at least one roller retaining recess, and wherein the cam plates achieve a maximum separation when the tapered roller reaches the shallow portion of the ramped surfaces of each of the respective recesses, and wherein the maximum separation is less than the tapered roller diameter at a radial pitch location.

9. The steering column assembly of claim 6, wherein the tapered roller has a length greater than or equal to a diameter of the tapered roller at a radial pitch location.

10. The steering column assembly of claim 6, wherein tie cam thrust assembly further includes,
at least two roller retaining recesses defined in the cam plate;
a tapered roller positioned in each of the at least two roller retaining recesses; and
a retainer configured to receive the tapered rollers and maintain a generally equal circumferential distance between the tapered rollers.

11. A cam thrust assembly comprising:
a tapered roller having a length greater than or equal to twice a radius of the tapered roller at a radial pitch location;
at least two cam plates, at least one of the cam plates being rotatable;
at least one roller retaining recess defined in each cam plate and having an inner radius and an outer radius, the retaining recess in each cam plate defining a ramp surface having a shallow portion and a deep portion, the tapered roller positioned in the roller retaining recess in each cam plate on the ramp surfaces for movement along the ramp surfaces;
wherein at least a portion of the ramp surfaces are curved between the shallow portion and the deep portion in the direction of the tapered roller travel;
wherein the ramp surfaces have a radius at the radial pitch location that is less than or equal to the tapered roller radius at the pitch location;
wherein the cam plates achieve a maximum separation when the roller reaches the shallow portion of the ramp surfaces of each of the respective recesses; and
wherein the maximum separation is less than twice the roller radius at the radial pitch location.
